(19) United States
(12) Patent Application Publication
(10) Pub. No.: US 2024/0201086 A1
(43) Pub. Date: Jun. 20, 2024

(54) Polymer-Supported Infrared Sensing Apparatus and Method

(71) Applicant: Environmental Material Science Inc., Saskatoon (CA)

(72) Inventors: Steven SICILIANO, Saskatoon (CA); Bipinlal UNNI, Saskatoon (CA); Callum DOOLIN, Edmonton (CA); Curtis SENGER, Osler (CA); Ian BURGESS, Saskatoon (CA)

(21) Appl. No.: 18/542,047

(22) Filed: Dec. 15, 2023

Related U.S. Application Data
(60) Provisional application No. 63/433,313, filed on Dec. 16, 2022.

(51) Int. Cl. G01N 21/552

(52) U.S. Cl. CPC G01N 21/554

(57) ABSTRACT

A sensor apparatus includes a waveguide, a sensing layer, a light source for emitting light onto the waveguide, and a detector for detecting a wavelength transmitted from the waveguide. The sensing layer may include a polymer layer which may come into intimate contact with a sample matrix of the environment.

### BENEFIT OF EARLIER APPLICATION

This application claims priority from U.S. provisional application 63/433,313, filed Dec. 16, 2022.

### TECHNICAL FIELD

The present invention relates to infrared sensing apparatus and methods in general, and polymer-supported infrared sensing apparatus and methods in particular.

### BACKGROUND

Absorption spectroscopy methods (such as Fourier-transform infrared spectroscopy) are used to measure how much light a sample absorbs at various wavelengths. Such methods have numerous applications. Such methods are typically conducted in a laboratory using bulky, complicated, and expensive equipment. Accordingly, it is impractical, if not impossible, to use such methods in the field or at scale.

In the prior art, analyzing light absorption over a broad range of spectral regions for a molecule of interest typically requires bulky apparatus, such as a Fourier transformed IR (FTIR) spectrometer, that require a laboratory setting and are impractical or have limited utility for on-site applications, e.g., on farms where frequent or even constant monitoring of soil may be desired over a large area. It is to be appreciated that although farming and soil are used as illustrative examples, the apparatus and methods discussed herein have other applications.

Full spectral analysis of analyte molecules is not generally required for on-site applications, e.g., where certain aspects of the sample are known or irrelevant, and therefore monitoring and/or quantification of only some aspects is desired, for which full spectral analysis is not required and partial spectral analysis provides sufficient utility. In such circumstances, FTIR spectrometers and other bulky apparatus would be impractical and would provide unnecessary data, and the cost and complexity of miniaturizing such apparatus would be onerous. Accordingly, there is a demand for scalable, cost-effective apparatus and methods that can sense, monitor, and/or quantify certain analytes of interest on-site, without the need manually to obtain samples to test in a laboratory.

Molecular structures with a change in dipole moment during molecular vibration can absorb energy from the mid-infrared (MIR) region ranging from approximately 4,000 to 400 cm⁻¹ (2.5 to 25 μm) of the electromagnetic spectrum. The frequency of the absorbed radiation corresponds to the vibrational frequency of the molecular bond that undergoes asymmetric stretching or bending motions. Such molecular motions are referred to as infrared (IR) active vibrations. The molecular bonds characterizing different chemical entities, or functional groups, have different characteristic absorption frequencies in the MIR region. The stretching vibrations require more energy, and therefore show characteristic IR absorption bands at higher frequencies. For example, the C—H stretching frequencies of hydrocarbons occur in the range of 2800 to 3300 cm⁻¹ (3 to 3.3 μm). The intensity of the IR absorption band depends on the polarity of the bond responsible for IR absorption at that frequency, and the number of bonds contributing to the IR absorption at that frequency. For example, decane, a major fraction of petroleum hydrocarbon (PHC) shows very strong IR absorption between 2850 and 3000 cm⁻¹ originating from the multiple C—H bond vibrations from its carbon chain.

Generally, for the fabrication of MIR-sensor systems, prior knowledge of the IR absorption band frequencies and intensities of the target molecule is required so that one may select or configure an appropriate light source and detector. Such sensor systems do not require a broadband light source and highly sensitive detectors, but only require a narrow band IR light source, e.g., a non-dispersive IR (NDIR) light source, and a simple IR detector, such as a multichannel pyroelectric detector.

Optical configuration refers to the arrangement of optical components within a detection system that allows MIR radiation from an IR light source to interact with material of interest and subsequently reach a detector. The optical configuration of the MIR detection system depends on the physical nature of the material of interest. For sensing analytes of interest in gaseous form, the detection system requires a simple transmission mode in which the IR radiation from the source travels straight from the source to the detector. Here, the gas molecules with a change in dipole moment present in the light path absorb MIR radiation at its characteristic vibrational frequencies and the gas concentration can be computed from the reference and sample channel of the IR detector. The transmission of MIR radiation does not occur through the sample in the case of liquid or solid samples, since the MIR radiation is absorbed into the sample matrix.

An exemplary optical configuration for IR-based analysis of a liquid or solid sample is attenuated total reflection (ATR). ATR requires an optical platform (e.g., a prism) that is optically transparent to MIR radiation, and is referred to as an MIR waveguide. The refractive index of the MIR waveguide (n_{wg}) must be higher than the refractive index of the environment or sample matrix (n_{c}). In an ATR configuration, the MIR light source reaches the optical platform incident at an angle equal to or greater than the critical angle for the formation of total internal reflection (θ_{c}=sin⁻¹(n_{wg}/n_{c}), i.e. Snell's law).

During the total internal reflection of IR light along the waveguide, a propagating evanescent electromagnetic field forms at the waveguide-air interface. An analyte material sample, placed at the surface of the MIR waveguide, interacts with the evanescent field at the waveguide-sample interface, leading to the attenuation of the propagating radiation at analyte-specific frequencies. The distance travelled by the evanescent wave into the material of interest over which the amplitude of the evanescent wave falls to 1/e times (or approximately 37%) its initial amplitude is called the depth of penetration (dp). The dp and the intensity of the evanescent wave may be affected by several factors, including the wavelength of the light (shorter wavelengths are associated with shallower dp), the angle of incidence of the light (steeper angles of incidence are associated with shallower dp), and the index of refraction of the crystal (higher indexes of refraction are associated with shallower dp).

An MIR waveguide that is used in conventional ATR configurations (such as the Kretschmann configuration) is one embodiment of an internal reflection element (IRE). IREs are made of materials that are transparent to radiation in the MIR range of frequencies. Frequently used materials for fabricating IREs are zinc selenide (ZnSe), zinc sulphide (ZnS), silicon (Si), diamond, and germanium (Ge). These crystals that may be used for ATR are available in various geometries including multi-reflection ATR rods, trapezoids, single reflection hemispheres, and microgrooved thin wafers. These conventional ATR crystals may be complemented by a range of optical fibres made of fluoride glasses, chalcogenide glasses or polycrystalline silver halides that are transparent to radiation at MIR wavelengths. Sophisticated examples of MIR waveguides include thin film waveguides and/or integrated optical waveguides (IOW), which are fabricated by depositing thin films of semi-conducting oxides (for example, indium tin oxide) on a refractive index matched substrate. Unlike conventional ATR crystals, MIR optic fibres and IOWs have a thickness in the range of micrometres (e.g., 1 to 1,000 micrometres). As the number of internal reflections is inversely proportional to the thickness of the IREs, the micrometre-range thickness of MIR fibres and IOWs generates a continuous evanescent field at the interface between an IRE and a sample.

### SUMMARY OF INVENTION

In accordance with a broad aspect of the present invention, there is provided a sensor apparatus, comprising a waveguide; a sensing layer coupled to the waveguide; a light source for emitting light onto the waveguide; and a detector for detecting a wavelength transmitted from the waveguide.

In accordance with another broad aspect of the present invention, there is provided a sensor apparatus, comprising a casing having a tubular body with a lengthwise opening; a waveguide having an incidence point and a transmission point; a sensing layer coupled to the waveguide, the sensing layer including a metal layer and a polymer layer, the metal layer being between the waveguide and the polymer lay; a light source positioned to emit light into the waveguide via the incidence point; a detector positioned to detect light from the waveguide via the transmission point; an objective between the light source and the incidence point, for focusing light from the light source onto the incidence point; and a second objective between the transmission point and the detector for focusing light from the transmission point onto the detector.

In accordance with yet another broad aspect of the invention, there is provided a method for sensing a condition of a matrix of the environment, comprising: emitting light of a first frequency onto a waveguide of a sensor, the waveguide being coupled to a sensing layer, the sensing layer being in intimate contact with the matrix, the sensing layer including a polymer layer and a metal layer; and detecting a second frequency transmitted from the waveguide.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Furthermore, the various embodiments described may be combined, mutatis mutandis, with other embodiments described herein. Accordingly, the drawings and detailed descriptions are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

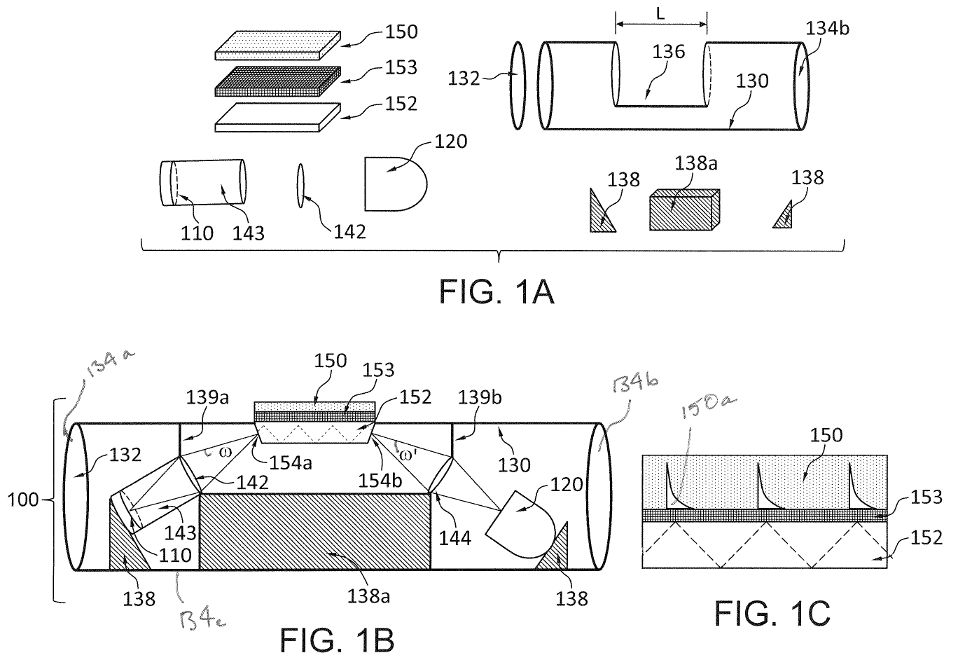

(a) FIG. 1A is an exploded schematic illustration of a polymer-supported infrared sensing apparatus in accordance with one embodiment of the present invention;

(b) FIG. 1B is an assembled schematic illustration of a polymer-supported infrared sensing apparatus in accordance with another embodiment of the present invention;

(c) FIG. 1C is a schematic illustration of an evanescent field formation in accordance with yet another embodiment of the present invention;

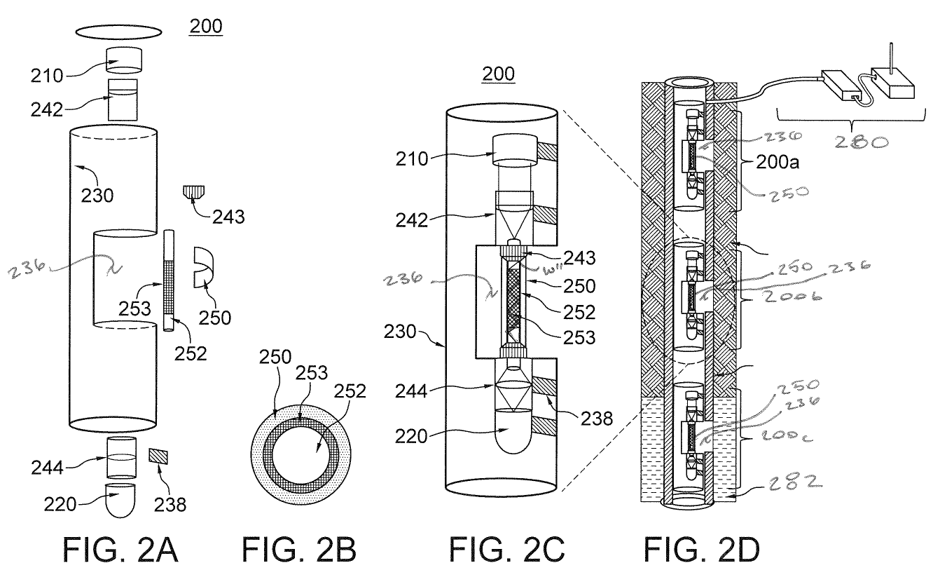

(d) FIG. 2A is an exploded schematic illustration of a polymer-supported infrared sensing apparatus in accordance with yet another embodiment of the present invention;

(e) FIG. 2B is a cross-sectional view of an assembled embodiment of the sensing layer, metal layer, and waveguide of the apparatus of FIG. 2A, in accordance with yet another embodiment of the present invention;

(f) FIG. 2C is an assembled schematic illustration of the embodiment of FIG. 2A shown in operation, in accordance with yet another embodiment of the present invention;

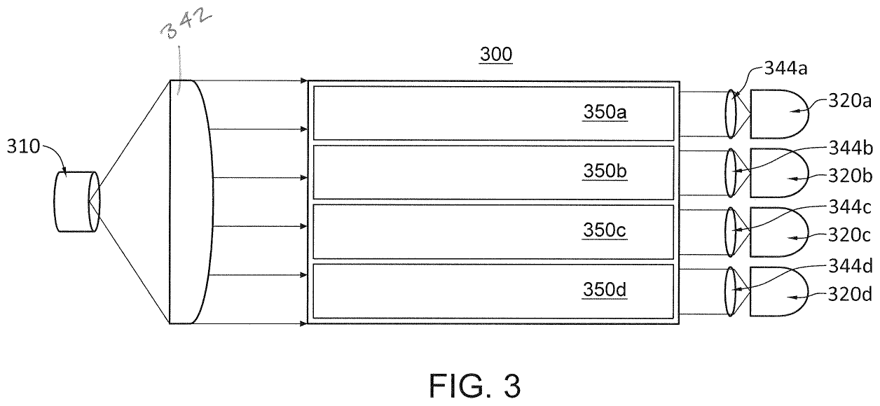

(g) FIG. 2D is a schematic illustration of multiple sensors arranged in a common casing, shown in use in the environment, according to yet another embodiment of the present invention; and (h) FIG. 3 is a schematic illustration of a sensor with multiple detectors, in accordance with yet another embodiment of the present invention.

### DETAILED DESCRIPTION OF EMBODIMENTS

The detailed description set forth below in connection with the appended drawings is

intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

An MIR-sensing device for a liquid or solid sample matrix requires three main components: (1) an MIR light source, (2) an IR detector, and (3) a waveguide for propagating MIR radiation from the light source to the sample, and after the radiation interacts with the sample, and from the sample to a detector.

A polymer-supported IR sensing apparatus and method is provided. FIGS. 1A and 2B illustrate a polymer-supported surface plasmon resonance sensor 100 according to one embodiment of the present invention. Sensor 100 may include a casing 130 to act as a housing for other components of the sensor. Casing 130 may be a hollow body, e.g., an elongate tube with end caps 132 on either or both ends 134a, 134b of the tube.

The casing may include a structure to permit a detector of the sensor to come into contact with material from the environment. For example, the casing may have an open segment 136, which may be defined by a length L of the casing where a radial portion, for example, ¾ of the tubular wall, is open, e.g., removed or recessed. In other words, there may be a gap in the casing, which may be defined by radial and lengthwise dimensions. Alternatively, or additionally, there may be perforations in the casing to permit the detector to come into contact with the environment.

The sensor 100 may include a light source 110 and a detector 120, which may be disposed within the casing. The sensor may include a waveguide 152, which may have any geometry that allows total internal reflection of light. A sensing layer 150 may be coupled to, e.g., disposed on, the waveguide. The sensing layer may include a polymer and/or a thin metal layer 153, or a combination of a polymer and a thin metal film, or a polymer with a dispersed metal film. Various illustrative options for polymers are discussed below. The light source may include an IR light source, e.g., a thermal emitter, and/or a laser.

In use, the light source may emit a light wave ω onto the waveguide, e.g., to an incidence point 154a on an incidence surface of the waveguide. With reference to FIG. 1C (which illustrates evanescent waves formed over waveguide 152 and metal layer 153), the light may thereby create an evanescent wave 150a that may penetrate into the sensing layer 150. The sensing layer may be thicker, e.g., 2.5 to 5.5 times thicker, e.g., 3-5 times thicker, than the depth of penetration (dp). At least a portion of the light wave ω may transmit as a transmitted light wave ω′ from proximate transmission point 154b to detector 120.

With reference to FIG. 1C, there may be a metal layer 153 between the waveguide 152 and the polymer 150. The metal layer may also be referred to as the plasmonic layer, and may enhance the IR signal of the analyte molecule. The plasmonic layer may include gold, silver, and/or copper. The metal layer may be characterized as having a surface plasmon resonance property with respect to the frequency of incident light. Upon shining a light of a specific frequency onto the metal layer, free electrons at the surface of these metals may oscillate at the same frequency as the incident light. This phenomenon may result in an enhanced electromagnetic field around the metal surface. The analyte near the metal surface may absorb more energy from the incident light compared to embodiments without metal layer 153.

Embodiments like the one shown in FIG. 1B may function without the metal layer or without the polymer layer, though such embodiments may provide less sensitivity and selectivity for the analyte of interest, compared to embodiments with both of such layers. The polymer layer may act as a filter to allow only the analyte of interest to reach the sensing surface (e.g., on the waveguide's surface). The combination of the metal layer and the polymer in the sensing layer, as shown in FIG. 1B, advantageously provides a sensor with improved selectivity and enhanced sensitivity of particular analytes.

The metal layer 153 may able to generate surface plasmons.

Plasmons are collective oscillations of free electrons, and are inherent to noble metals. Plasmons can be characterized as mechanical oscillations of free electrons in an external electric field, which cause the displacement of free electrons of an ionic core, i.e., a nucleus and core electrons. The frequency at which the plasmons oscillate is called the plasma frequency. The density of free electrons affects the plasma frequency. The electromagnetic waves that travel along a metal-dielectric or metal-air interface are called surface plasmon polaritons (SPPs), the surface plasmon referring to the charge motion in the metal, and polariton referring to the electromagnetic waves in the air or dielectric.

A condition referred to as surface plasmon resonance (SPR) arises when the collective oscillation of free electrons of the surface plasmon is in resonance with the frequency of incident light. The surface plasmon becomes confined to the particle's surface when the particle's size is comparable to the wavelength of incident radiation, a condition referred to as localized surface plasmon (LSP). Accordingly, SPR provides light-matter interactions in a nanoscale structure with sub-wavelength light confinement and an enhanced electric field at the metal surface, which exponentially falls off with distance due to dampening effects, e.g., optical loss.

Dielectric permittivity (ε) determines a material's response to exposure to electromagnetic radiation (e.g., in the context of the instant apparatus and method, incident light). In other words, the dielectric function of a given material determines its capacity to support a surface plasmon. Dielectric permittivity is a function of a wavelength (λ) of incident light, and is expressed as a complex number (ε=εᵣ+i εᵢ). The real part (εᵣ) describes the phase difference between the frequency of incident radiation and the plasma frequency (i.e., slowing down of the light in the material), and the imaginary part (εᵢ) is the dampening factor (e.g., loss due to absorption).

Material property required to achieve SPR can be explained by Mie theory, according to which a simplified expression for the extinction cross-section (Cₑₓₜ), which is the total radiant flux scattered or absorbed by the material of a metal nanosphere, is:

$${C}_{ext} = \frac{σ}{λ} [ \frac{{ε}_{i}}{{( {ε}_{r} + 2 {ε}_{m} )}^{2} + {ε}_{i}^{2}} ]$$

where σ is a constant, and εₘ is the dielectric function of the medium surrounding the nanomaterial.

According to Mie theory, the condition for SPR is satisfied if the real part of the dielectric function (εᵣ) of the metal becomes close to −2εₘ. In that condition, the extinction coefficient reaches a maximum, and the absorption and scattering at that frequency becomes stronger. Plasma frequency is determined by the wavelength at which εᵣ=−2εₘ.

Metals, including gold, silver, copper, and aluminum, satisfy the resonance conditions and have plasmon resonance in ultraviolet and visible light spectra. Meanwhile, dielectric and non-metals typically have εᵣ between 1 and 50, and therefore do not generally adequately support resonance conditions. Copper and aluminum have limited plasmonic application due to their susceptibility to form oxides which may inhibit their capacity to generate SPR. Silver may be disadvantageously affected by halide formation upon exposure to air, but silver provides a strong and sharp plasmon resonance curve in the UV region, making it a favourable choice of plasmonic metal for sensing applications. Gold is advantageous as a plasmonic metal since it supports strong resonance in a wide span of the electromagnetic spectrum from UV to near-IR, and is not prone to oxidation. In practical applications, advantages of material properties of certain metals may outweigh some inefficiencies in plasmonic properties, so it is to be appreciated that various types of metals may be used depending on the application, the analyte of interest, and the matrix in which it is being examined.

As mentioned above, the density of free electrons affects the plasma frequency of the metal layer. Plasmonic metals have a fixed density of free electrons, and the resulting resonance frequencies are generally in spectral range of UV to near-IR. However, e.g., in the case of gold and silver, the plasmon frequency can be extended to the mid-IR range by creating isolated nanometal structures. This may be achieved via sputtering or vapour-deposition of metal (e.g., gold and/or silver) films on IREs with minimal deposits. For example, a gold film that is approximately 40 to 70 nanometer-thick may provide such an isolated metal structure.

The metal layer of the instant sensor (e.g., metal layer 153 of FIG. 1B) may include an SPR formation in the mid-IR range, e.g., manufactured by sputtering a gold film on the waveguide (e.g., waveguide 152 of FIG. 1B).

It is to be appreciated that the light source, the waveguide, the sensing layer, and the detector may be positioned with respect to one another to permit the aforementioned reflection and evanescent wave. For example, the various components may be coupled to the casing, e.g., via one or more positioners 138, to arrange the various components as described herein. The light source may be positioned to emit light toward the incidence point, and the detector may be positioned to detect light from the transmission point, and specifically to detect characteristics of the light including, e.g., wavelength and/or amplitude, which can be interpreted to determine characteristics of the environment, or of the sample brought into contact with the sensing layer.

In the illustrated embodiment of FIG. 1B, the casing may have an elongate tube structure with ends 134a and 134b. The light source may be positioned proximate end 134a of the casing and proximate a first side 134c of the casing (as illustrated, on the bottom of the casing), and the detector may be positioned proximate end 134b proximate the first side of the casing. The light source and the detector may each be angled toward a waveguide 152 on or proximate a second side of the casing (as illustrated, on the top of the casing) diametrically opposed to first side 134c. It is to be appreciated that the terms “top” and “bottom” used herein are merely illustrative of possible relative positions of the detector, light source, and waveguide, and any number of orientations is possible.

The light source may be angled toward an incidence point 154a of waveguide 152, and the detector may be angled toward a transmission point 154b of the waveguide. The waveguide may have an axial length, and incidence point 154a and transmission point 154b may be on either end of the axial length of the waveguide. The ends of the waveguide may be tapered inward toward an axis of the casing such that the incidence point 154a may receive wavelengths from the light source and transmission point 154b may transmit wavelengths to the detector 120.

It is to be appreciated that light travels within and along the waveguide from the incidence point to the transmission point. In one embodiment, the incidence point and the transmission point may be the same location, in which case they may be collectively referred to as the reflection point.

There may be an optical refocusing objective 142 between the light source and waveguide 152, which in use may focus light wave ω from light source 110 to incidence point 154. Objective 142 may be coupled to light source 110 via optical coupler 143. Optical coupler 143 may be an elongate cylindrical structure extending from proximate the light source to proximate objective 142 and may have a diameter substantially the same as that of objective 142. Further, and in the alternative, objective 142 may be secured to the casing via a positioner 138a and/or a coupling 139a.

There may be a second optical refocusing objective 144 between the waveguide and the detector, which in use may focus light wave ω′ from transmission point 154b to detector 120. Objective 144 may be positioned between the transmission point 154b and the detector, for example, by being secured to the casing via a positioner 138a and/or a coupling 139b. There may be a second optic coupler, e.g., between the second optical refocusing objective and the detector.

The light source, waveguide, and detector may be arranged in what is known in the art as a Kretschmann or attenuated total reflection (ATR) configuration. The positions of the light source and detector may be selected and/or tuned to maximize throughput. The optic couplers may be used to position the refocusing objectives and the waveguides in the desired positions. Components may be assembled on a solid substrate and secured inside a slotted conduit, e.g., open segment 136. The ends of the conduit may be capped. The caps may be integral with the conduit, or may be separate structures. The end caps may have holes therein for electrical cables to pass therethrough, e.g., for providing means for communication and/or for providing electrical power to the sensor.

The sensor may be calibrated by comparing the absorbance of light detected at certain emitted frequencies corresponding to analytes of interest. Sensors may be calibrated against various standards (made in a matrix including, for example, one or more of liquid, gas, sand, grain, and/or powder) of the analytes of interest, including, for example, volatile organic carbons, carbon dioxide, methane, semi-volatile and non-volatile petroleum hydrocarbons, etc. In other words, the sensor may be used in one or more control samples, and the detected light characteristics may be recorded, such that comparisons can be made with subsequently detected signals. Further, or alternatively, such data may be displayed at a user interface. In one embodiment, a processor may be configured to monitor the signals received by the detector, and record data to a database, and/or upon certain triggering events, such as if a change beyond a certain threshold is detected, e.g., which may suggest an increase in moisture content of the matrix, or any number of other changes in characteristics of the matrix or analyte, and the processor may communicate an alert a user via the user interface. The alert may inform the user of such a change and its corresponding predicted event. In one embodiment, monitoring may include periodically activating the detector and recording detected characteristics of light, e.g., on a monthly, weekly, daily, hourly, or even on a continuous or constant basis.

The sensor may be positioned in the field such that materials of the environment, such as soil or groundwater, may be in direct contact with the sensing layer. The sensor may include and/or be coupled to a communication module for remote control of, and/or communication with, the light source, the detector, and the polymer-coated waveguide. The assembled components may be arranged such that, in use, the sensing layer is exposed to the environment for intimate contact therewith, while other components, namely the light source and the detector, are shielded from the environment by the casing.

The optical refocusing objectives may include collimating lenses made of IR transparent materials like ZnSe or calcium monofluoride (CaF), with adjustable optical alignment. The conduit may be made of a material such as polyvinyl chloride (PVC) and/or aluminum. The waveguides may include one or more suitable structures, such as a micro-grooved wafer, a hemisphere, or a prism. The detector may be a pyroelectric IR detector, e.g., a multichannel detector in which one channel is used as a reference and one or more other channels are used for measuring light absorbed by an analyte of interest.

FIG. 2A and FIG. 2B illustrate another embodiment of the present invention. A sensor 200 has a casing 230. The casing may have an open segment 236. Sensor 200 may include a light source 210 and a detector 220. Sensor 200 may include a waveguide 252.

The waveguide may be positioned in the light path between the light source and the detector in order to convey light ω′ from the light source to the detector. The waveguide may be positioned via an optic coupler 243. The components of the sensor may be mounted on a solid substrate (e.g., of the casing) using one or more device positioners 238. Waveguide 252 may be arranged such that its longitudinal axis substantially aligns with that of light source 210 and/or detector 220. There may be an optical refocusing objective 242 disposed between light source 210 and waveguide 252, for focusing light from the light source onto an end of the waveguide, e.g., via the optic coupler 243. There may be a second optical refocusing objective 244 disposed between the waveguide and the detector, for focusing light from the waveguide onto the detector.

Waveguide 252 may include an optic fibre, including, e.g., chalcogenides, polycrystalline, indium, and/or zirconium fluoride glass. The waveguide may include a mid-IR fiber.

A metal layer 253 in combination or with a sensing layer 250 may be disposed on the waveguide. For example, the waveguide may be wrapped, coated, enveloped, or otherwise coupled with the sensing layer 250 or with the metal layer 253 such that light travelling through the waveguide may be affected by the sensing layer. During manufacture, the waveguide may be cleaned, e.g., using mechanical polishing and/or sonication in solvents such as isopropyl alcohol. This cleaning may be done prior to applying the sensing layer to the waveguide. The metal layer 253 can be disposed onto the waveguide by various methods of metal deposition, for example, one or more of plasma sputtering, vapor deposition and electroless deposition. A thin layer (e.g., having a thickness of 3 to 15 nanometers, such as between 5 to 10 nanometers) comprising conductive metal oxide such as indium tin oxide or indium zinc oxide may be sputtered on the waveguide surface prior to the sputtering deposition of the metal layer (such as gold), to improve the adhesion of metal layer onto the waveguide's outer surface. The sensing layer may be grafted onto the waveguide substrates with or without the metal layer by lamination, dip coating, spin coating, plasma bonding and/or electrospinning. For example, the waveguide may be spin-coated or dip-coated into a polymeric solution to form a thin layer of polymer on the waveguide. Further, or in the alternative, a pre-fabricated thin layer of polymer may be plasma-bonded (or otherwise coupled) to the waveguide. The waveguide and sensing layer assembly may be treated, e.g., via annealing in a drying oven at a glass transition temperature of a polymer of the sensing layer. The casing may be water-resistant, e.g., water-tight.

FIG. 2D illustrates an embodiment of the invention wherein multiple sensors 200a, 200b, 200c, share a common casing. The sensors 200a, 200b, 200c are arranged axially, one after the other. As shown, the lower sensor 200a is submerged in water 282, with a gap 236 permitting solid or liquid matter of the environment to come into contact with the sensing layer 250. In use, the materials of the environment may act on the sensing layer and thereby on the light passing through the waveguide. Such changes on the light may be detected by the detector.

The sensor may further include, or may be in communication with, a communication module 280 as shown in FIG. 2D. The communication module may permit communication of data to and/or from the sensor, for example, from the detector to a computer.

With reference to FIG. 3, in one embodiment, a sensor 300 may include multiple detectors, e.g., detectors 320a, 320b, 320c, and 320d. The sensor may include a plurality of waveguides each coated with a sensing and/or metal layer 350a, 350b, 350c, 350d respectively. Sensor 300 may include a light source 310. Sensor 300 may include an optical refocusing objective 342 between the light source and the plurality of waveguides. Sensor 300 may include further optical refocusing objectives 344a, 344b, 344c, 344d, between each of the waveguides and their corresponding detectors. While the detectors illustrated in FIG. 3 are arranged one on top of the other, it is to be appreciated that any number of arrangements is possible, e.g., a side-by-side arrangement.

Multiple bands of different polymers may be coated on a single waveguide with a sufficiently wide surface area. Further, or in the alternative, each polymer can be coated on individual waveguides.

Permeation of organic molecules into polymeric materials has been used in various industrial applications, including controlled drug delivery, barrier materials, and preconcentration of media for sensors. Mid-IR polymer-clad attenuated total reflectance can be used as a sensing method with an FTIR spectrometer. In polymer-coated ATR methodologies, analytes may be extracted (e.g., as solvents from a matrix) from the environment into the membrane (e.g., the sensing layer), being in intimate contact with the IR waveguide material of a high refractive index, e.g., approximately 1-5, e.g., 2-5, for a polymer cladding with a refractive index of approximately 1.4 (e.g., 1.1 to 1.7).

Prior art generally uses a single type of polymer as a preconcentrating material. This preconcentrating polymer layer may lack specificity for analytes of interest. A broad range of analytes may be absorbed into the sensing layer. In such cases, overlapping of the IR spectral bands belonging to multiple absorbed analytes is common, reducing the reliability of data and analysis. In the prior art, several types of preconcentrating polymers have been used for ATR-IR analysis. Multiple bands of polymers may be included in a sensing layer of a single IR waveguide apparatus. To be clear, there may be multiple polymers on a single waveguide, or there may be multiple waveguides each with its own unique polymer applied thereon.

The apparatus may be characterized as having a polymeric array of sensing layers, in which light through each polymer-coated waveguide is routed to the detector, which may include a multi-channel detector and/or a plurality of detectors. The polymer(s) for the sensing layer(s) may be selected according to the analyte(s) of interest. Each sensing layer may have one or more polymers. The various sensing layers may have common and/or distinct polymers.

In testing, the sensor was shown to be capable of simultaneously detecting multiple analytes, including, e.g., F2, F3 petroleum hydrocarbons, BTEX (benzene, toluene, ethylbenzene and xylene), and moisture in the soil of the environment being tested by the sensor.

Polymers may enrich the analyte molecule via adsorption based on their physical properties and the physical properties of the analytes of interest. The sensitivity may depend, e.g, on the analyte concentration within the polymer once exposed thereto, which depends at least partly on a partition coefficient for the analyte between the analyte matrix (e.g., soil and/or water), and the polymer. Other properties of the polymer that may be considered in the selection thereof include the polymer's degree of crystallinity and its glass transition temperature. Highly crystalline polymers have relatively compact chains and a relatively small distance between chains. Crystalline regions of a polymer have reduced analyte diffusion. In contrast, the amorphous phase of the polymer has disordered chains that form the free volume, into which analytes can diffuse easily. Another polymeric property, glass transition temperature (Tg), influences diffusion. Tg is the temperature above which the polymer changes from a quasi-crystalline to a liquid-like structure. At Tg, polymeric chains in amorphous regions of the polymeric matrix gain enough thermal energy to begin to slide past each other. Below the Tg, disordered chain motion is substantially immobile.

Some polymers may have IR absorption peaks that fall at the same or close to the characteristic IR absorption frequencies of the analytes. The background IR adsorption from the polymer matrix may interfere with the sensing of analytes. Accordingly, another factor for choosing the polymer for the sensing layer is to minimize interfering absorption bands in the mid-infrared region of interest.

Thus, the suitability of the polymer as an enrichment layer for detection of a specific analyte in the environment (e.g., soil and water matrices) depends at least in part on: (i) chemical partition coefficient, (ii) crystallinity, and (iii) interferences of the polymer.

Although any number of polymers may be used without departing from the scope of the present invention, the polymers discussed herein are examples of those that may be used. Polydimethylsiloxane (PDMS) has SiO(CH₃)₂ repeating units that may constitute (or be included in) the main chain of the polymer present in the sensing layer.

Partitioning here includes the separation of the analyte from its sample matrix, based on a similar chemical nature (e.g., the polarity) of the polymer and the analyte. The non-polar characteristics of PDMS provides a relatively high partition coefficient for non-polar hydrocarbons. PDMS with copolymer (poly[dimethylsiloxane-co-[3-(2-(2-hydroxyethoxy)ethoxy)propyl]methylsiloxane]) may be useful, since the bulky side chain on the polymer backbone is expected to increase the free volume of the polymer matrix. The increased free volume is expected to enhance the diffusion of hydrocarbon components from the sample matrix.

Highly crystalline polymers have rigid polymeric networks, in which case there will be little or no free volume for the analyte to diffuse into the polymer matrix. Crosslinking of the polymer backbone provides rigid structures. For example, a PDMS polymer solution Sylgard™ 184, manufactured by Dow Chemicals™, contains vinyl terminated methoxysiloxanes to act as a crosslinker for the PDMS polymeric chains. PDMS is a polymer with Tg below room temperature (e.g., approximately −127° C., which provides a relatively loosely structured polymeric matrix.

PDMS generally has IR absorption bands between approximately 2,964 and 2,905 cm⁻¹. In testing, it was observed that the peaks of absorbed frequencies are not shifting or changing upon adsorption of hydrocarbon analytes into the polymers, and hence do not substantially interfere with the hydrocarbon sensing.

Several types of chemically functionalized PDMS molecules are commercially available. Chemically functionalized here includes to have introduced more chemical entities, such as hydroxyls (OH), amine (NH₂), etc., to the polymer chain.

In one embodiment, the polymer may include hydroxy terminated PDMS (OH-PDMS), which may improve the selectivity of the polymer layer in respect of analytes with relatively greater polarity. OH-PDMS can also increase the crosslinking of the polymer structure, and thereby improve the mechanical stability of the polymer layer. OH-PDMS may have a relatively high partition coefficient for polar hydrocarbon analytes.

Crosslinking of OH-PDMS may be achieved using polymethylhydroxysilane (PMHS), which has a different structural composition than crosslinked PDMS of Sylgard™. This structural difference in the polymer matrix may alter the analyte selectivity of the sensor. Polymers with altered functional groups such as OH and NH₂ may prefer to bind with analyte moles with similar chemical functionalities. Literature shows that like PDMS, OH-PDMS generally does not have interferences with the IR absorption frequencies of the target analytes.

Polyisobutylate (PIB) may be a relatively more responsive polymer because of its enhanced reversibility of absorption. Reversibility is an important quality in choosing the polymer(s) for the sensing layer. The reversibility of its partitioning is a strong performance characteristic for an environmental detector. For example, in testing, PIB was observed to provide relatively good structural stability upon absorbing BTEX, and regenerates to its initial form by relieving the analytes from its matrix quickly (e.g., within approximately 30 minutes, such as in under 15 minutes). PIB has a strong IR absorption band at 952 cm⁻¹, which is much further away from the IR absorption frequencies of BTEX materials.

The sensing layer may include, for example, one or more of polydimethylsiloxane (PDMS), functionalized PDMS, Nafion™, polybenzimidazole (PBI), polyaniline, polypyrrole, and zeolites. PDMS-coated IREs may be used for detecting aliphatic hydrocarbons; Nafion™ may be used for detecting cations such as Na+ and K+; polybenzimidazole may be used for detecting BTEX; and zeolites may be used for F1 fraction of PHCs. It is to be understood that such examples are simply illustrative, and other polymers may be used, and/or the listed polymers may be used for different applications.

The light emitted by the IR light source may be of a particular range. For example, the emitted light may be in the IR spectrum. The IR light source may include, for example, a thermal emitter, a globar, and/or a quantum cascade laser. The light source may emit light of a narrower range, such as the mid-IR region, substantially within a range of wavelengths of 2-30 μm, e.g., wavelengths of 2.5-25 μm.

A sensor is provided. In one embodiment, the sensor may be able to detect one or more fractions of petroleum hydrocarbons, and/or moisture in the environment, e.g., in soil. For example, the sensor may be able to detect aliphatic hydrocarbons such as decane, aromatic hydrocarbon such as benzene, and soil moisture with PDMS, PBI and OH-PDMS respectively in the sensing layer coupled to the IR waveguide.

The sensor may include a housing (e.g., casing 130) configured for being partially or entirely buried in soil. The sensor may include a detector capable of detecting frequencies of light. Such light may be first emitted by a light source onto a sensing layer and then transmitted from the sensing layer to the detector. The sensing layer, and any material in contact therewith, may affect the light wave's frequency when detected at the detector.

The housing may include a communications module for receiving detected information from the detector and communicating the detected information to a database, e.g., via a telecommunications signal.

Each sensing layer may include: (i) a waveguide, for example, in the form of an infrared IRE and/or an infrared-capable fibre optic cable, (ii) a plasmonic surface coated on the waveguide, the plasmonic surface including a metal selected to have properties to induce SPR in the desired IR range to be responsive to the analyte of interest; and (iii) a polymer coated on the plasmonic surface, the polymer selected to have properties that change in response to certain materials or conditions of interest, e.g., changes in petroleum hydrocarbon fraction concentrations and/or moisture.

Polymers with ion exchange properties may be used. Perfluorosulphonic acid (PFSA) polymers may be used, for example, for moisture and/or salinity sensing applications. More than one type of polymer may be required to sufficiently detect changes in all of H₂O, K+, Na+, NH₄+, and/or NO₃—.

The apparatus may include multiple sensors arranged on cables which may be configured in loops or pathed along materials of interest to collect data at multiple locations from multiple sensors.

The sensor may be configured to detect properties and changes in the sensor's polymer layer by continuously monitoring the frequencies detected by the detector. The sensor may have polymers selected to filter certain wavelengths corresponding to conditions or materials of interest. The selection of polymers for the filters depends on the IR absorption characteristics of the target analyte molecules. For example, pyroelectric dual channel detectors with a 4.3 micron filter may be suitable for hydrocarbon detection.

In operation in the context of a farming application, at least a portion of the sensor may be brought into contact with, or even entirely buried in, soil. The detected conditions may be communicated via the communications module which may include a computer for processing instructions, analyzing data, and/or displaying data.

### Clauses

Clause 1. A sensor apparatus, comprising: a waveguide; a sensing layer coupled to the waveguide; a light source for emitting light onto the waveguide; and a detector for detecting a wavelength transmitted from the waveguide.

Clause 2. The apparatus of any one or more of clauses 1-16, wherein the sensing layer includes a polymer layer.

Clause 3. The apparatus of any one or more of clauses 1-16, wherein the sensing layer includes a metal layer.

Clause 4. The apparatus of any one or more of clauses 1-16, wherein the sensing layer includes a metal layer and a polymer layer, the metal layer being between the waveguide and the polymer layer.

Clause 5. A method of manufacturing the apparatus of any one or more of clauses 1-16, comprising sputtering a gold film on the waveguide.

Clause 6. A method of manufacturing the apparatus of any one or more of clauses 1-16, comprising sputtering a gold film on the waveguide.

Clause 7. The apparatus of any one or more of clauses 1-16, further comprising an objective between the light source and the waveguide.

Clause 8. The apparatus of any one or more of clauses 1-16, further comprising a second objective between the waveguide and the detector.

Clause 9. The apparatus of any one or more of clauses 1-16, further comprising a casing to act as a housing of the apparatus, the casing having a hollow body with an opening to permit the sensing layer to come into contact with the environment.

Clause 10. The apparatus of any one or more of clauses 1-16, wherein: the light source is disposed proximate a first end of the casing and proximate a first side of the casing; the detector is disposed proximate a second end of the casing and the first side of the casing; and the waveguide is disposed between the first end and the second end proximate a second side of the casing, such that the light source and the detector are each angled toward the second side and thereby toward waveguide.

Clause 11. The apparatus of any one or more of clauses 1-16, wherein: the light source, the waveguide, and the detector are arranged coaxially, the waveguide being between the light source and the detector; and the sensing layer is disposed radially about the waveguide.

Clause 12. The apparatus of any one or more of clauses 1-16, wherein the sensing layer includes polydimethylsiloxane.

Clause 13. A sensor apparatus, comprising: a casing having a tubular body with a lengthwise opening; a waveguide having an incidence point and a transmission point; a sensing layer coupled to the waveguide, the sensing layer including a metal layer and a polymer layer, the metal layer being between the waveguide and the polymer lay; a light source positioned to emit light into the waveguide via the incidence point; a detector positioned to detect light from the waveguide via the transmission point; an objective between the light source and the incidence point, for focusing light from the light source onto the incidence point; and a second objective between the transmission point and the detector for focusing light from the transmission point onto the detector.

Clause 14. A method for sensing a condition of a matrix of the environment, comprising: emitting light of a first frequency onto a waveguide of a sensor, the waveguide being coupled to a sensing layer, the sensing layer being in intimate contact with the matrix, the sensing layer including a polymer layer and a metal layer; and detecting a second frequency transmitted from the waveguide.

Clause 15. The method of any one or more of clauses 1-16, further comprising: interpreting the second frequency by comparing the second frequency with a previously obtained frequency detected from a control matrix.

Clause 16. The method of any one or more of clauses 1-16, further comprising: monitoring the second frequency and communicating an alert to a user if a triggering event occurs.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element or step. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A sensor apparatus, comprising:
a waveguide;
a sensing layer coupled to the waveguide;
a light source for emitting light onto the waveguide; and
a detector for detecting a wavelength transmitted from the waveguide.

2. The apparatus of claim 1, wherein the sensing layer includes a polymer layer.

3. The apparatus of claim 1, wherein the sensing layer includes a metal layer.

4. The apparatus of claim 1, wherein the sensing layer includes a metal layer and a polymer layer, the metal layer being between the waveguide and the polymer layer.

5. A method of manufacturing the apparatus of claim 3, comprising sputtering a gold film on the waveguide.

6. A method of manufacturing the apparatus of claim 4, comprising sputtering a gold film on the waveguide.

7. The apparatus of claim 1, further comprising an objective between the light source and the waveguide.

8. The apparatus of claim 1, further comprising a second objective between the waveguide and the detector.

9. The apparatus of claim 1, further comprising a casing to act as a housing of the apparatus, the casing having a hollow body with an opening to permit the sensing layer to come into contact with the environment.

10. The apparatus of claim 9, wherein:
the light source is disposed proximate a first end of the casing and proximate a first side of the casing;
the detector is disposed proximate a second end of the casing and the first side of the casing; and
the waveguide is disposed between the first end and the second end proximate a second side of the casing, such that the light source and the detector are each angled toward the second side and thereby toward waveguide.

11. The apparatus of claim 1, wherein:
the light source, the waveguide, and the detector are arranged coaxially, the waveguide being between the light source and the detector; and
the sensing layer is disposed radially about the waveguide.

12. The apparatus of claim 1, wherein the sensing layer includes polydimethylsiloxane.

13. A sensor apparatus, comprising:
a casing having a tubular body with a lengthwise opening;
a waveguide having an incidence point and a transmission point;
a sensing layer coupled to the waveguide, the sensing layer including a metal layer and a polymer layer, the metal layer being between the waveguide and the polymer lay;
a light source positioned to emit light into the waveguide via the incidence point;
a detector positioned to detect light from the waveguide via the transmission point;
an objective between the light source and the incidence point, for focusing light from the light source onto the incidence point; and
a second objective between the transmission point and the detector for focusing light from the transmission point onto the detector.

14. A method for sensing a condition of a matrix of the environment, comprising:
emitting light of a first frequency onto a waveguide of a sensor, the waveguide being coupled to a sensing layer, the sensing layer being in intimate contact with the matrix, the sensing layer including a polymer layer and a metal layer; and
detecting a second frequency transmitted from the waveguide.

15. The method of claim 14, further comprising:
interpreting the second frequency by comparing the second frequency with a previously obtained frequency detected from a control matrix.

16. The method of claim 14. further comprising:
monitoring the second frequency and communicating an alert to a user if a triggering event occurs.
